(19) United States
(12) Patent Application Publication
(10) Pub. No.: US 2024/0222668 A1
(43) Pub. Date: Jul. 4, 2024

(54) CRYOGENIC FLUID AS CATHODE AIR COOLANT

(71) Applicant: Joby Aero, Inc., Santa Cruz, CA (US)

(72) Inventors: Robert Gulliver Lynn, Auckland (NZ); Jeffrey Allen Lotterman, Los Angeles, CA (US); Benjamin Brelje, Ann Arbor, MI (US)

(21) Appl. No.: 18/398,824

(22) Filed: Dec. 28, 2023

Related U.S. Application Data
(60) Provisional application No. 63/477,496, filed on Dec. 28, 2022.
(60) Provisional application No. 63/534,662, filed on Aug. 25, 2023.

(51) Int. Cl. H01M 8/04701; H01M 8/04007; H01M 8/04029; H01M 8/04111; H01M 8/04223

(52) U.S. Cl. CPC H01M 8/04738; H01M 8/04029; H01M 8/04037; H01M 8/04074; H01M 8/04111; H01M 8/04253; H01M 2250/20; H01M 2250/405

(57) ABSTRACT

A fuel cell system includes a fuel cell for receiving hydrogen from a supply of hydrogen. The system comprises a heat exchanger for transferring heat to the hydrogen from a coolant fluid located in a cooling loop. The cooling loop comprises a number of cooling cores located in a conduit that supplies air to the fuel cell. A compressor compresses air cooled by the cooling cores to provide compressed air to the fuel call. The cooling cores may be de-iced by a coolant fluid that has been warmed by operation of the fuel cell. Fuel cell system efficiency can be increased by cooling the air to be supplied to the fuel cell before or after compressing it.

### RELATED APPLICATION DATA

This application claims the benefit of U.S. Provisional Patent Application No. 63/534,662 filed on Aug. 25, 2023 and U.S. Provisional Patent Application No. 63/477,496 filed on Dec. 28, 2022, the contents of both of which are incorporated herein by reference as if explicitly set forth.

### TECHNICAL FIELD

This disclosure relates generally to the field of fuel cells fueled by liquid hydrogen, including for example for use in electrically-powered or hybrid-powered aircraft.

### BACKGROUND

A fuel cell is an electrochemical cell that converts the chemical energy of a fuel (often hydrogen) and an oxidizing agent (often oxygen) into electricity through a pair of redox reactions. Fuel cells have been used to generate electrical power in many applications. Fuel cells are used for primary and backup power for commercial, industrial, and residential buildings and in remote or inaccessible areas. They are also used to power fuel cell vehicles, including forklifts, automobiles, buses, trains, boats, motorcycles, and submarines.

Fuel cell vehicles are powered by hydrogen that is fed into an onboard fuel cell “stack,” which transforms the hydrogen's chemical energy into electrical energy. This electricity is then available to power the vehicle and its onboard systems.

Hydrogen supplied to a fuel cell enters the anode, where it comes in contact with a catalyst that promotes the separation of hydrogen atoms into an electron and proton. The electrons are gathered by the conductive current collector, which is connected to the vehicle's high-voltage circuitry, feeding an onboard battery and/or electric motors that propel the vehicle. The byproduct of the reaction occurring in the fuel cell stack is water vapor, which is emitted through an exhaust.

Also included in fuel cell powered vehicles is a “balance-of-plant,” which contains all of the other components of a fuel cell system except the stack itself. This includes pumps, sensors, heat exchangers, gaskets, compressors, recirculation blowers or humidifiers, and so forth.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a plan view of an aircraft according to some examples.

FIG. 2 is a schematic view of an aircraft energy system according to some examples.

FIG. 3 is a schematic diagram illustrating a hydrogen fuel cell system, according to some examples.

FIG. 4 is a schematic diagram illustrating a compressor inlet air cooling system according to some examples.

FIG. 5 is a schematic diagram illustrating the coolant paths in the air cooling system of FIG. 4.

FIGS. 6A & 6B are a flowchart illustrating operation of the fuel cell system including the air cooling system of FIG. 4, according to some examples.

FIG. 7 is a schematic diagram illustrating an inlet air compression and cooling system, according to some examples.

FIG. 8 is a schematic diagram illustrating a cooling section of a multi-section inlet air hydrogen-based cooler for use in an inlet air cooling system according to some examples.

FIG. 9 is a schematic diagram illustrating a hydrogen-based cooler comprising multiple cooling sections, according to some examples.

FIG. 10 is a schematic diagram illustrating a de-icing system for use in an inlet air cooling system, according to some examples.

FIG. 11 is a schematic diagram illustrating a cooling section of a combined de-icing and air cooling system for use in an inlet air cooling system according to some examples.

FIG. 12 is a schematic diagram illustrating air cooling system for use in a fuel cell system according to some examples.

FIG. 13 is a flowchart 1300 illustrating operation of the fuel cell system 300 including the air cooling systems illustrated in FIG. 8 to FIG. 12, according to some examples.

FIG. 14 illustrates a diagrammatic representation of a machine in the form of a computer system within which a set of instructions may be executed for causing the machine to perform any one or more of the methodologies discussed herein, according to some examples.

### DETAILED DESCRIPTION

The following description of examples of the invention is not intended to limit the invention to these examples, but rather to enable any person skilled in the art to make and use this invention.

Air for use by a fuel cell, which is obtained from the surrounding environment, is typically compressed to a suitable pressure for efficient use by the fuel cell. Compressing the ambient air increases its temperature. Accordingly, it is beneficial to cool the ambient air before or after compression.

On the other hand, hydrogen for use by the fuel cell needs to be warmed and expanded from a hydrogen tank for use by the fuel cell. The cold hydrogen can advantageously be used to cool the ambient air before and/or after one or more stages of compression. Depending on the moisture content of the air, water can condense out of the air during cooling and freeze on the corresponding heat exchanger. Disclosed herein are various example configurations using hydrogen to cool ambient air for fuel cell use, and to perform any needed deicing.

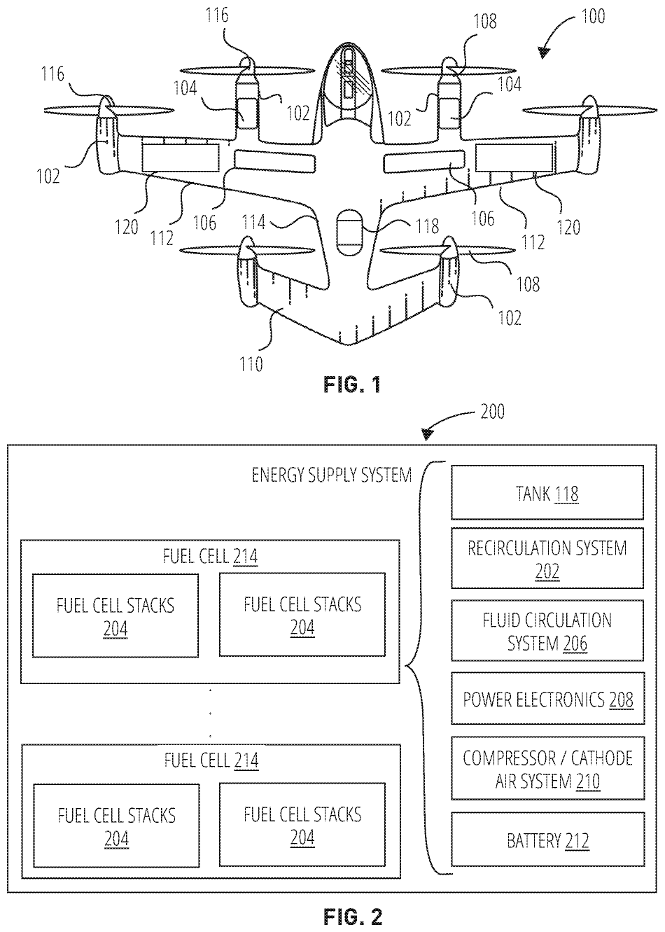

FIG. 1 is a plan view of an aircraft 100 according to some examples. The aircraft 100 includes a fuselage 114, two wings 112, an empennage 110, and propulsion systems 108 embodied as ducted fans or rotor assemblies 116 located in nacelles 102. The aircraft 100 includes one or more fuel cell power sources embodied in FIG. 1 as nacelle fuel cell stacks 104 and wing fuel cell stacks 106, although cell stacks could also be provided in the fuselage 114. One or more heat exchangers 120 are located in the wings 112 and/or fuselage 114 or other locations. The aircraft 100 will also typically include associated equipment such as an electronic infrastructure, control surfaces, a cooling system, landing gear and so forth.

The wings 112 function to generate lift to support the aircraft 100 during forward flight. The wings 112 can additionally or alternately function to structurally support the fuel cell stacks 104, 106 and/or propulsion systems 108 under the influence of various structural stresses (e.g., aerodynamic forces, gravitational forces, propulsive forces, external point loads, distributed loads, and/or body forces, and so forth).

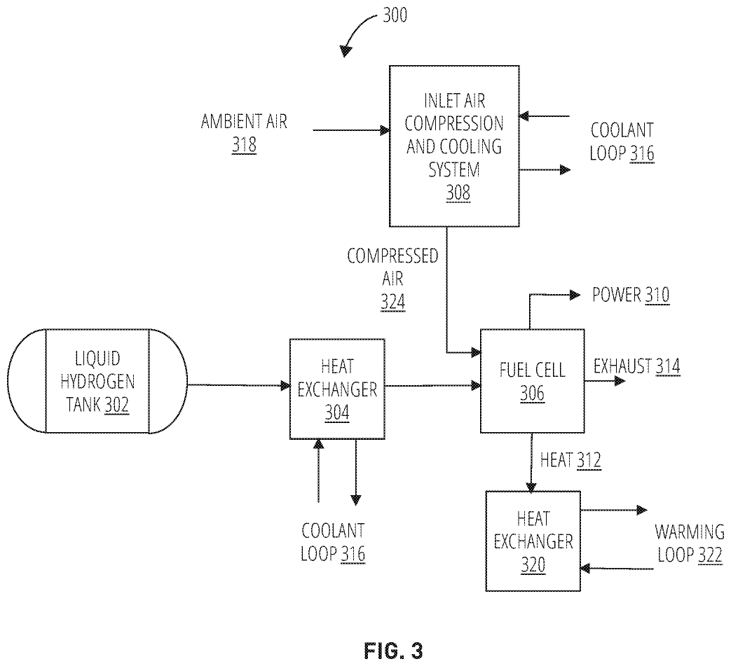

FIG. 2 is a schematic view of an aircraft energy supply system 200 according to some examples. As shown, the energy supply system 200 includes one or more fuel cells 214. Each fuel cell 214 may include one or more fuel cell stacks 204.

Typically associated with a fuel cell 214 are a source of hydrogen such as a liquid or compressed gaseous hydrogen tank 118, a recirculation system 202 for supplying hydrogen from the tank 118 and for returning anode-outlet hydrogen to the fuel cell 214, a coolant fluid circulation system 206 for transferring heat, power electronics 208 for regulating delivery of electrical power from the fuel cells 214 during operation and to provide integration of the fuel cells 214 with the electronic infrastructure of the aircraft 100, a compressor/cathode air system 210 for providing compressed air to the fuel cells 214, and one or more batteries 212.

The one or more batteries 212 provide energy storage for start-up, for peak power loads, load following, and also for control and avionics safety in case of a failure in the fuel cell system. The electronic infrastructure includes energy supply management system, for monitoring and controlling operation of the fuel cells 214.

The fuel cells 214 function to convert chemical energy into electrical energy for supply to the propulsion systems 108. Fuel cells 214 can be arranged and/or distributed about the aircraft in any suitable manner. Fuel cell stacks can be arranged within wings (e.g., inside of an airfoil cavity), inside nacelles, and/or in any other suitable location on the aircraft.

The energy supply system 200 can optionally include a heat transfer system (e.g., fluid circulation system 206) and/or that functions to transfer heat from or to various components of the aircraft 100, for example by circulating a working fluid within a fuel cell 214 to remove heat generated during operation, to provide heat for evaporation of liquid hydrogen from the tank 118, or to remove heat from other heat-generating components within the aircraft 100.

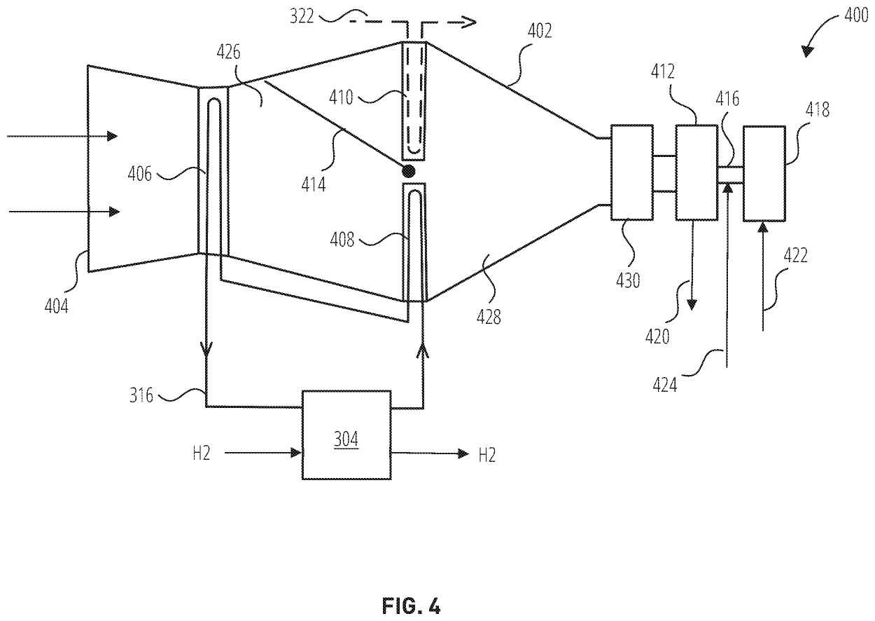

FIG. 3 is a schematic diagram illustrating a hydrogen fuel cell system 300, according to some examples. The fuel cell system 300 comprises a liquid hydrogen tank 302, a heat exchanger 304, an inlet air compression and cooling system 308 and a fuel cell 306. For purposes of clarity, additional components associated with a fuel cell system 300, such as a hydrogen recirculation loop, have not been illustrated.

The liquid hydrogen tank 302, as its name suggests, stores liquid hydrogen for use in the fuel cell 306. The liquid hydrogen tank 302 is connected to, and supplies liquid hydrogen to the heat exchanger 304, which adds heat to the hydrogen before supplying it to the fuel cell 306.

The heat exchanger 304 provides cooling, via a coolant loop 316, to other heat-generating systems, such as the fuel cell 306 or to the inlet air compression and cooling system 308, which is used to compress the air containing the oxygen used by the fuel cell 306. The coolant loop 316 includes a coolant liquid or gas, which in some examples can be the hydrogen itself, either isolated or in fluid communication with the hydrogen supplied to the fuel cell 306, that can be circulated to and from a heat source, such as the inlet air compression and cooling system 308 or other heat source, to cool the heat source. In some examples, the cold hydrogen gas leaving the liquid hydrogen tank 302 may cool a heat source more directly, for example by having the heat exchanger 304 located at or near the heat source, such as in or near the inlet air compression and cooling system 308.

The inlet air compression and cooling system 308 compresses and cools compressed ambient air 318 for supply to the fuel cell as compressed air 324 at the pressure required by the fuel cell 306. Compressing the ambient air 318 increases its temperature. The coolant from the coolant loop 316 is thus used to cool the ambient air 318 as described in more detail below. Supplying cooler air to a compressor included in the inlet air compression and cooling system 308 reduces its power consumption.

Warmer hydrogen gas leaving the heat exchanger 304 is received by the fuel cell, which together with the compressed air received from the inlet air compression and cooling system 308, generates electrical power 310, heat 312 and a water vapor exhaust 314 as is known in the art. Some of the heat 312 that is generated by the operation of the fuel cell 306 is removed by coolant flowing in a heat exchanger 320, as part of a warming loop 322. The warming loop 322 is used to provide de-icing of cooling elements used to cool the ambient air 318 in the inlet air compression and cooling system 308, as will be described in more detail below. In most cases, the bulk of the heat from the fuel cell will be removed by a radiator exposed to ambient air in a separate cooling loop (not shown).

Circulation of coolant in the coolant loop 316 and warming loop 322 is provided by appropriate pumps (not shown in FIG. 3)

In some examples the coolant loop 316 is also used to cool the fuel cell 306 in addition to or instead of cooling the ambient air 318 in the inlet air compression and cooling system 308.

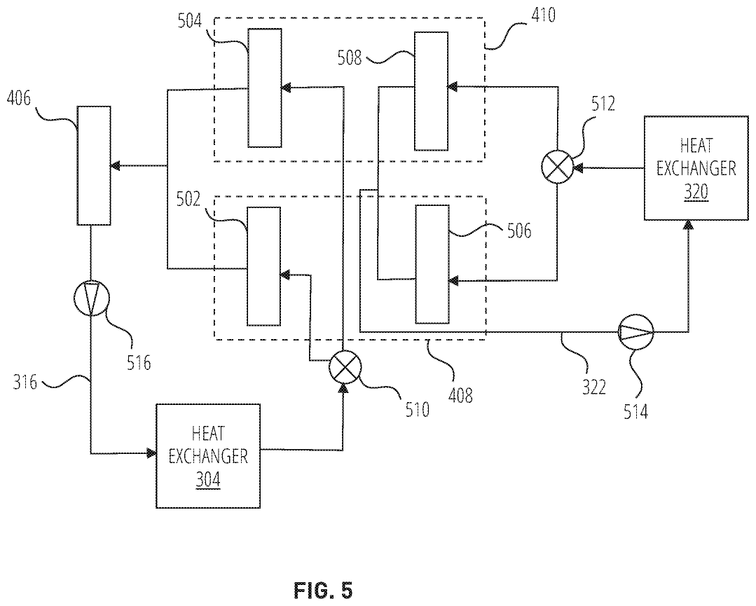

FIG. 4 is a schematic diagram illustrating a compressor inlet air cooling system 400 according to some examples. The inlet air cooling system 400 includes a body 402 having an inlet 404 for ambient air at one end thereof and a compressor 412 for compressing air for provision to the fuel cell 306. The body 402 defines a conduit along which air can flow from the inlet 404 to the compressor 412. The inlet 404 is at or in fluid communication with a port in the skin of the aircraft 100. The inlet air cooling system 400 also includes three cooling elements 406, 408 and 410 for cooling the ambient air before it reaches the compressor 412, although it will be appreciated that more or less than three cooling elements could be used based on design choices and the implementation.

Also provided is a vane 414 that can be moved between three positions under control of the power electronics 208; a first position (shown) in which the cooling element 410 is shielded from air received from the inlet 404, a second position (facing down in the figure) in which the cooling element 408 is shielded from air received from the inlet 404, and a third, central position in which inlet air can flow through both cooling elements 408, 410. The vane 414 is operated by a motor (not shown) and may be retained in its various positions by latching mechanisms.

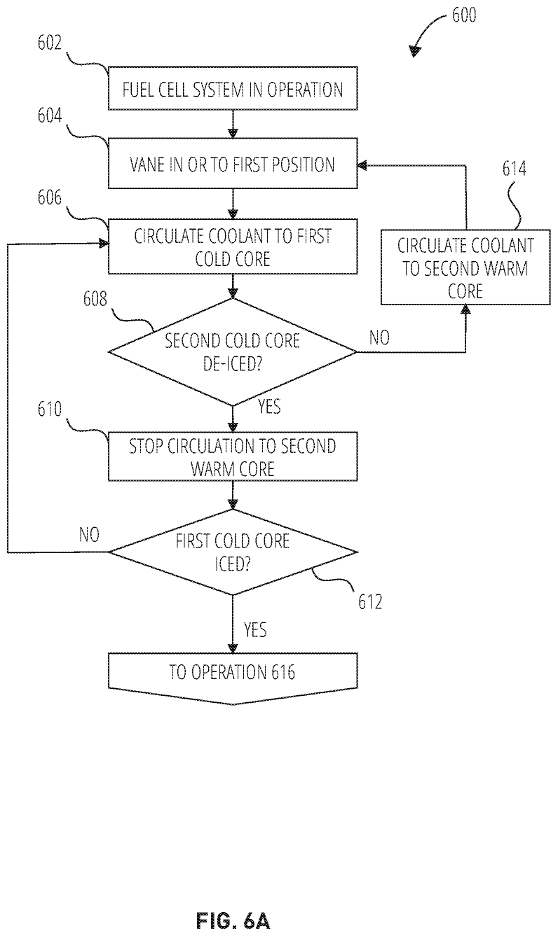

The cooling element 406 has a single cold core, while the cooling elements 408 and cooling element 410 each have warm cores 508 and 506 and cold cores 502 and 504 respectively, as shown in more detail in FIG. 5. The cooling element 406 and the cold cores 502 and 504 form part of the coolant loop 316 from the heat exchanger 304, and receive coolant that has been cooled by liquid hydrogen as discussed above with reference to FIG. 3. The warm cores 508 and 506 receive coolant that has been warmed in heat exchanger 320 by the heat 312 generated by operation of the fuel cell 306, via warm warming loop 322. For purposes of clarity and to illustrate one mode of operation, FIG. 4 shows cooling element 408 only receiving coolant from coolant loop 316 and cooling element 410 only receiving coolant from warming loop 322, which will occur when the vane 414 is in the first position, cooling element 410 is being de-iced, and cooling element 408 is providing cooling of the inlet air.

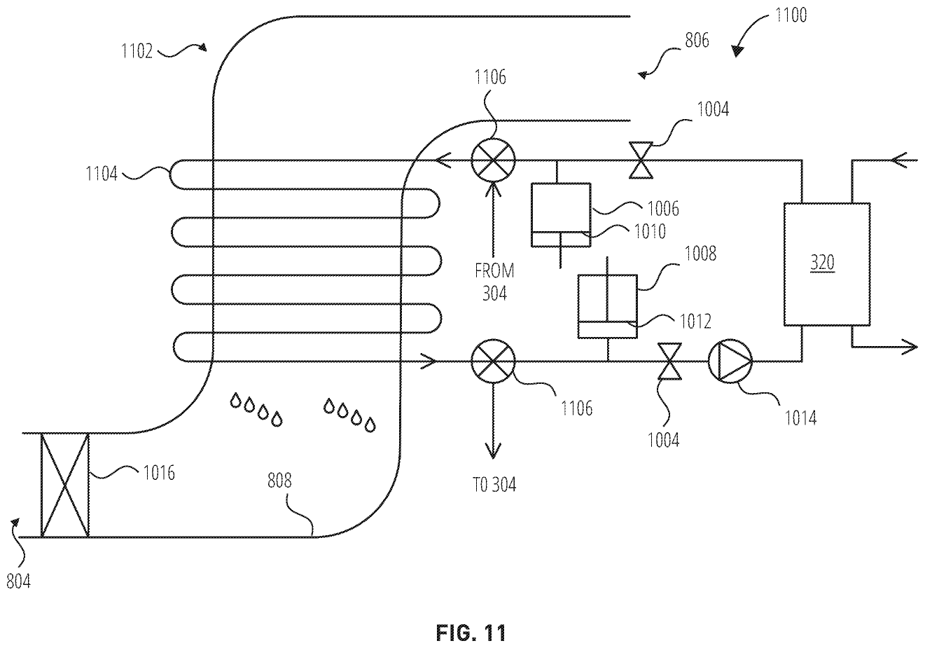

As discussed below, in particular with reference to FIG. 11, in some examples separate warm and cold cores are not provided, but one core is switched between cold and warm supplies of coolant in the same core passages. If separate warm and cool cores are provided, they will be in close thermal contact, such as having common air fins attached to both the warm and the cold channels of the respective warm and cold cores, to permit efficient melting of ice off the air fins when iced.

The compressor 412, which provides compressed air 420 to the fuel cell 306, is driven by a motor 416 that receives electrical power 424 from the power electronics 208. In some examples, a turbine 418, powered by fuel cell exhaust gas 422 provides additional mechanical power to assist the motor 416 in driving the compressor 412. This reduces the power consumption of the compressor 412. In some examples the stator of the motor 416 of the compressor 412 is cooled by hydrogen from the liquid hydrogen tank 302, either directly or via secondary liquid coolant, before it is used to cool the inlet air as described herein, to deeply sub-cool the stator of the motor 416 and thereby improve its efficiency by reducing the winding resistance of the stator.

As can be seen, the inlet air cooling system 400 can be divided by the cooling elements 406 and the cooling elements 408, 410 into a first chamber 426, and by the cooling elements 408, 410 and the compressor 412 into a second chamber 428, to provide a multistage cooling system. Air from inlet 404 is first cooled by the cooling element 406 and then air in chamber 426 is cooled further by one or both of cooling elements 408, 410 as it passes into chamber 428. To ensure that this can occur effectively, the coolant in coolant loop 316 flows from the heat exchanger 304 first to one or both of cooling elements 408, 410, and then to cooling element 406 after gaining heat from the airflow as it passes through cooling element 408 and/or cooling element 410. This ensures that a favorable temperature differential is maintained between the air in the chamber 426 and the coolant in the cooling elements 408 and/or 410.

For example, at ground level, the air temperature at inlet 404 may be 30 deg. C./80 deg. F., the air in chamber 426 is cooled to 0 deg. C./32 deg. F., while the air in chamber 428 is cooled to −50 to −80 deg. C./−58 to −112 deg. F. As the aircraft 100 gains altitude, the ambient air will get progressively colder, with corresponding decreases in temperature in the air in chambers 426 and 428.

At these temperatures, water vapor in the air is likely to condense and freeze on the cooling elements 408, 410. To resolve this problem, the vane 414 is moved to shield an iced-up cooling element (cooling element 410 in the example of FIG. 4) from the inlet air, the coolant flow through that cooling element is stopped, and a flow of warm coolant from heat exchanger 320 is circulated through the cooling element (410) via warming loop 322 to de-ice it. When the cooling element (410) has de-iced, the vane 414 is moved to a position in which air can pass through the cooling element, coolant flow through the cooling element from the warming loop 322 ceases and coolant flow from the coolant loop 316 resumes. These operations are performed by actuators and valves under control of the power electronics 208, and in response to sensors such as temperature sensors, which can be used to determine the state of the cooling elements 408, 410.

The presence of ice on a cooling element 408, 410 can be detected using conventional ice detection means, including for example an appropriately-located vibrating probe ice detector. Alternatively or in addition, pressure taps could identify a rise in the air pressure differential across the cooling element 408, 410 due to icing effects. Furthermore, as cooling element 408, 410 gets iced up its effectiveness goes down, resulting in a rapid rise in the temperature of the downstream air. An appropriately located downstream temperature sensor can thus be used to determine cooling element icing.

Also, depending on the thermal power being exchanged and the mass flow rate through the cooling element 408, 410, the fluid exit temperature could be monitored. As the cooling element's effectiveness drops, the fluid exit temperature increase will decline, and when the cooling element 408, 410, is completely iced and little or no air is passing through the cooling element 408, 410, the temperature differential between the fluid inlet and fluid outlet will be small. Temperature sensors could thus be used to monitor the temperature differential across the inlet and the outlet, or the temperature at the outlet, to determine cooling element icing.

Alternatively, de-icing could be performed without actually detecting ice (for example, every few minutes or 30 seconds) when icing conditions are anticipated through modeling based on known outside humidity and temperature.

Other methods of defrosting could also be used, such as by electrical power using a resistive heating scheme or by using vibration.

Also provided in some examples is an inertial separator unit 430 downstream of one or more of the cooling elements 406, 408, 410 but upstream of the compressor 412. Defrosting schemes have the potential to produce ice chunks that could damage the blades of the compressor 412, so either the defrost cycle has to be frequent enough to keep the maximum shed ice particle smaller than the smallest chunk that can damage the compressor 412, or an inertial separator unit 430 is included in the inlet air cooling system 400.

In some examples, an inertial separator unit is located between the cooling element 406 and the cooling elements 408, 410, because this would enable removal of almost all of the water (in liquid form at this stage) before the airflow reaches the cooling elements 408, 410. This will reduce the rate of ice formation on the cooling elements 408, 410 and also the generation of ice/snow that could go into and damage the compressor 412. There is also a thermodynamic benefit to removing the water prior to the cooling elements 408, 410, which take the air temperature below freezing, because this increases the amount of thermal power used to cool the air down instead of wasting it on the water phase-change from liquid to solid.

If this first inertial particle separator unit is effective enough, based on its design and also how well the air temperature drop across the cooling element 406 manages to condense all of the water from vapor to liquid, then a second inertial particle separator unit downstream may not be needed, but in practical terms an inertial particle separator unit 430 after the cooling elements 408, 410 and before the compressor 412 is likely to be included.

Still further, one or more processors, for example in the power electronics 208, or other aircraft control systems, may include logic to inhibit cryogenic cooling altogether when humidity and temperature indicates that particularly severe icing conditions may be present.

FIG. 5 is a schematic diagram illustrating the coolant paths in the inlet air cooling system 400 of FIG. 4. As can be seen, cooling element 408 includes a cold core 502 and a warm core 506, while cooling element 410 includes a cold core 504 and warm core 508.

The cold cores 502, 504 are supplied with coolant from the heat exchanger 304 via coolant loop 316, which branches upstream of cold cores 502, 504 before rejoining to pass through cooling element 406. Coolant flow from the heat exchanger 304 to the cold cores 502, 504 is controlled by a multi-position valve 510 that is in turn controlled by the power electronics 208. Circulation in warming loop 322 is effected by pump 514, while circulation in coolant loop 316 is effected by pump 516.

The warm cores 506, 508 are supplied with coolant from the heat exchanger 320 via coolant warming loop 322, which branches upstream of warm cores 506, 508 before rejoining to return to the heat exchanger 320. Coolant flow from the heat exchanger 320 to the warm cores 506, 508 is controlled by a multi-position valve 512 that is in turn controlled by the power electronics 208.

Flow through the coolant loop 316 and the warming loop 322 is controlled by the valves 510, 512 to provide cooling of inlet air and de-icing of the cooling elements as discussed above with reference to FIG. 4. This is done in conjunction with operation of the vane 414.

In a first mode, the vane 414 is positioned so as to shield the cooling element 410 from air flowing from the inlet 404, as shown in FIG. 4, to permit it to be de-iced. In this mode, the valve 510 is positioned so that flow is only directed to cold core 502 in cooling element 408 and not to cold core 504 in cooling element 410, while the valve 512 is positioned so as to direct flow to warm core 508 in cooling element 410 and not to warm core 506 in cooling element 408. The inlet air is thus cooled by cooling element 408 prior to compression by the compressor 412, while the cooling element 410 is de-iced by the warm core 508.

In a second mode, the vane 414 is positioned so as to shield the cooling element 408 from air flowing from the inlet 404, to permit it to be de-iced. In this mode, the valve 510 is positioned so that flow is only directed to cold core 504 in cooling element 410 and not to cold core 502 in cooling element 408, while the valve 512 is positioned so as do direct flow to warm core 506 in cooling element 408 and not to warm core 508 in cooling element 410. The inlet air is thus cooled by cooling element 410 prior to compression by the compressor 412, while the cooling element 408 is de-iced by the warm core 506.

In a third mode, the vane 414 is positioned centrally so as to permit flow of air through both cooling elements 408 and 410. The valve 512 is in a fully closed position and there is no coolant flow through the warming loop 322. In this mode, the valve 510 can be in a position in which coolant in coolant loop 316 is directed to either one or both of cold cores 504 and 502 depending on the cooling that is available or required. In the case in which only one cooling element 408 or 410 is required, coolant flow could be alternated between them to prevent ice from forming on either cooling element.

In some examples, instead of having separate cold and hot cores in the cooling elements 408, 410, the warming loop 322 and the coolant loop 316 could be valved alternately to a cooling elements 408, 410 each having a single core, as long as the coolant is the same fluid.

Furthermore, if the frost and ice generated on a core is dense enough, air will be mostly forced through the less-frosted pathway effectively acting as a “vane” without the weight and cost of a real blocking vane. In such a case, merely doing the reverse cycle heating of one of the two cooling elements 408, 410 at a time may be sufficient.

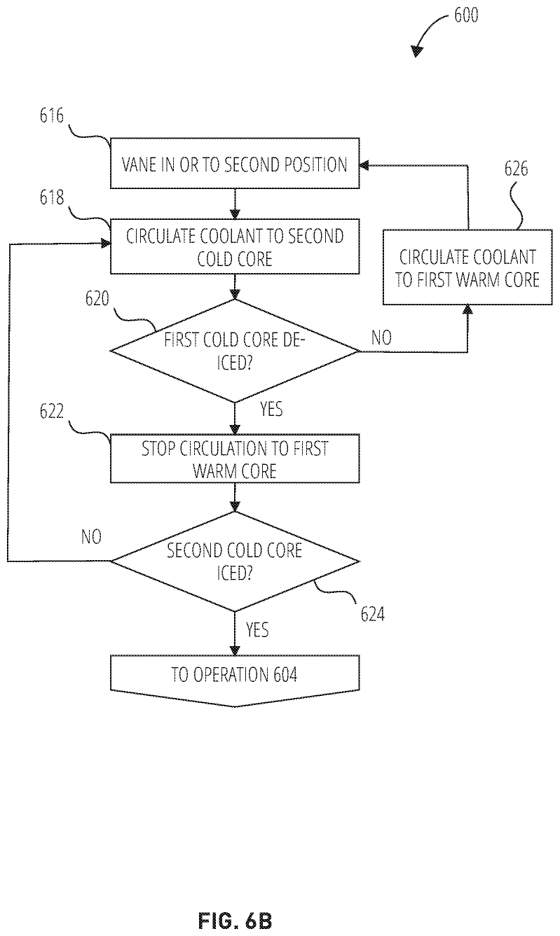

FIGS. 6A & 6B are a flowchart 600 illustrating operation of the fuel cell system 300 including the inlet air cooling system 400, according to some examples. The flowchart is performed by the fuel cell system 300 and inlet air cooling system 400 under computer control of the power electronics 208 or other aircraft system processors. The method steps are accomplished by the power electronics 208 providing control signals to corresponding components in the system, such as valves 510, 512, pumps 514, 516, and an actuator to position the vane 414. The method steps are initiated by the power electronics 208 based at least in part on signals received from sensors located in the systems 300, 400, including for example temperature sensors located in the cores of the cooling elements 408, 410.

The flowchart 600 commences at operation 602 in FIG. 6A, in which the fuel cell system 300 is operating. Liquid hydrogen from liquid hydrogen tank 302 is provided to the heat exchanger 304, where it receives heat from coolant flowing in the coolant loop 316. The hydrogen is then passed to fuel cell 306, which generates power 310, heat 312 and exhaust 314. Heat 312 from the fuel cell 306 is passed to the coolant in warming loop 322 in heat exchanger 320. Ambient air 318 received in inlet 404 of inlet air cooling system 400 is compressed by the compressor 412, cooled by the cooling element 406 and one or both of cooling elements 408, 410, and provided to fuel cell 306. Pump 516 is operating to circulate coolant through the coolant loop 316.

The method continues at operation 604, in which the vane is either in a first position or, if not in the first position, is moved into a first position corresponding to the first mode discussed above. In operation 606, coolant is circulated to a first cold core (e.g., cold core 502) by the power electronics 208 positioning the valve 510 accordingly and operating the pump 516.

In operation 608, the power electronics 208 determines whether a second cold core (e.g., cold core 504) is or has been de-iced, based on signals received from temperature sensors in or at the second cold core. If the second cold core has not been de-iced, coolant is circulated to a second warm core (e.g., warm core 508) by the power electronics 208 positioning the valve 512 accordingly and operating the pump 514 in operation 614, and the method returns to operation 604 and proceeds from there.

If the second cold core 504 is or has been de-iced, the method proceeds to operation 610 where coolant circulation to the second warm core 508 is terminated by the power electronics 208 shutting down the pump 514 and/or operating the valve 512 to prevent coolant flowing to the warm core 508.

It is then determined in operation 612 whether or not the first cold core 502 has become iced. If not, the method returns to operation 606 where coolant continues to circulate to the first cold core 502 and the method continues from there. If the first cold core 502 has become iced, then a condition is present in which the first cold core 502 has become iced and the second cold core 504 is not iced, and the method proceeds to operation 616.

The flowchart 600 then continues at operation 616 in FIG. 6B, in which the vane is either in a second position or, if not in the second position, is moved into a second position corresponding to the first mode discussed above. In operation 618, coolant is circulated to a second cold core (e.g., cold core 504) by the power electronics 208 positioning the valve 510 accordingly and operating the pump 516.

In operation 620, the power electronics 208 determines whether the first cold core 502 is or has been de-iced, based on signals received from temperature sensors in or at the first cold core 502. If the first cold core 502 has not been de-iced, coolant is circulated to a first warm core (e.g., warm core 506) by the power electronics 208 positioning the valve 512 accordingly and operating the pump 514 in operation 626, and the method returns to operation 616 and proceeds from there.

If the first cold core 502 is or has been de-iced, the method proceeds to operation 622 where coolant circulation to the first warm core 506 is terminated by the power electronics 208 shutting down the pump 514 and/or operating the valve 512 to prevent coolant flowing to the warm core 506.

It is then determined in operation 624 whether or not the second cold core 504 has become iced. If not, the method returns to operation 618 where coolant continues to circulate to the second cold core 504 and the method continues from there. If the second cold core 504 has become iced, then a condition is present in which the second cold core 504 has become iced and the first cold core 502 is not iced, and the method returns to operation 604, where the vane 414 is moved to its first position and the method proceeds from there.

The flowchart 600 continues for as long as the fuel cell system 300 is operating, in some examples.

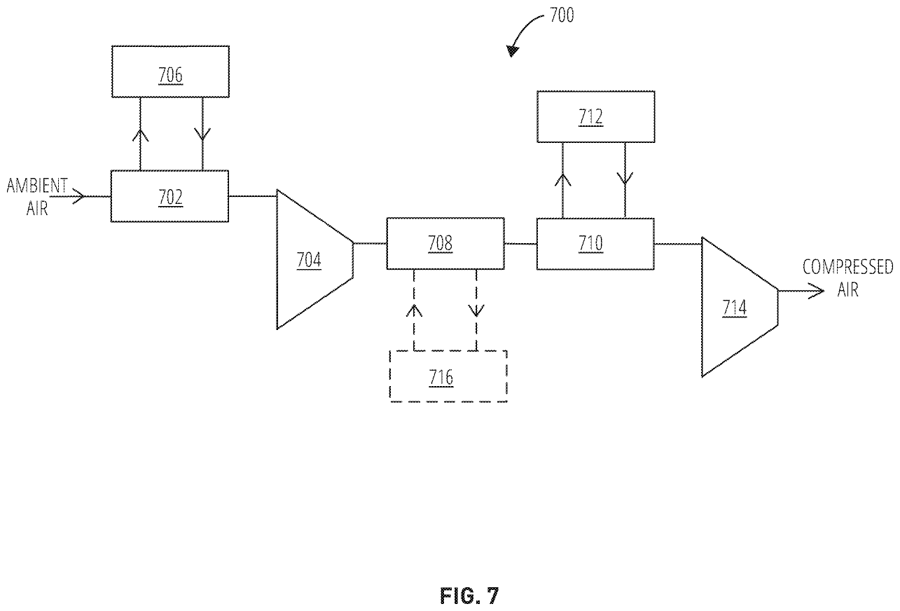

FIG. 7 is a schematic diagram illustrating the details of an inlet air compression and cooling system 700, according to some examples. The inlet air compression and cooling system 700 is an example implementation of the inlet air compression and cooling system 308 of FIG. 3. The inlet air compression and cooling system 700 illustrates that, in some examples, multiple stages of cooling and compression are provided in inlet air compression and cooling system 308.

The inlet air compression and cooling system 700 comprises a first stage of compression and cooling provided by a hydrogen-based cooler 702 and a compressor unit 704 operating on ambient air, and a second stage of cooling provided by an air-based cooler 708, a hydrogen-based cooler 710 and a compressor unit 714 operating on the compressed air received from the compressor unit 704.

The hydrogen-based cooler 702 is cooled directly or indirectly by hydrogen supplied from the liquid hydrogen tank 302, in some examples indirectly by a heat exchanger 706 such as heat exchanger 304 described above with reference to FIG. 3. Similarly, the hydrogen-based cooler 710 is cooled directly or indirectly by hydrogen supplied from the liquid hydrogen tank 302, in some examples indirectly by a heat exchanger 712 such as heat exchanger 304 described above with reference to FIG. 3.

The air-based cooler 708 is cooled by ambient air separate from the ambient air passing through and being compressed and cooled by the inlet air compression and cooling system 700. In some examples, the cooling ambient air flows over or between pipes carrying the compressed ambient air, and forming the air-based cooler 708, to cool the compressed air passing through the air-based cooler 708 directly, while in other examples the cooling ambient air cools coolant flowing through a heat exchanger 716 forming a coolant loop with a core located in the air-based cooler 708.

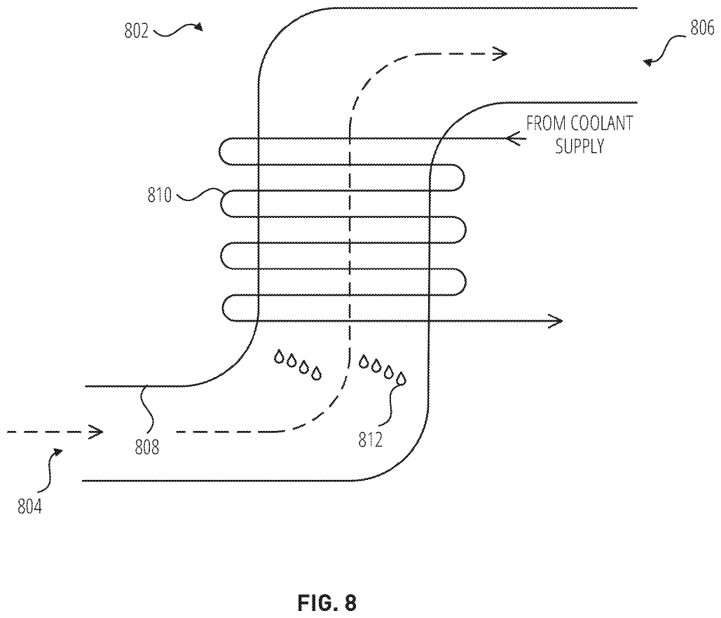

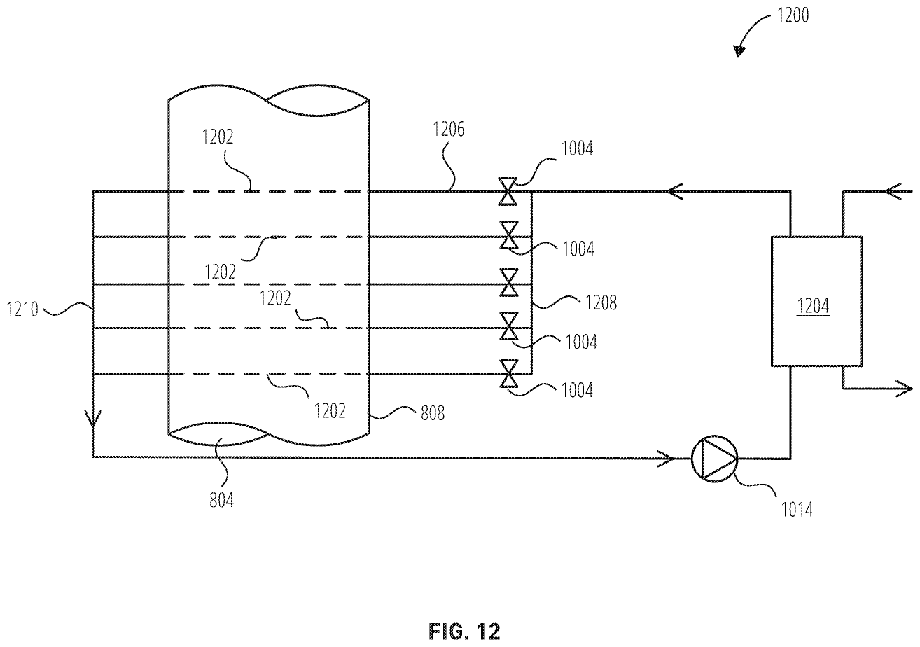

The hydrogen-based cooler 702 includes one or more cooling and deicing elements such as cooling elements 406, 408 or 410, one or more cooling sections 802, 1102 (see FIG. 8 to FIG. 10 below) and/or one or more cores 1202 (See FIG. 12 below) for cooling the ambient air 318 by transferring heat from the ambient air 318 to hydrogen from the liquid hydrogen tank 302. The hydrogen-based cooler 702 also includes one or more separator units 430 if required.

In some examples, the compressor unit 704 includes a compressor 412, a motor 416 and a turbine 418, and operates as described above with reference to FIG. 4.

Similarly, the hydrogen-based cooler 710 includes one or more cooling and deicing elements such as cooling elements 406, 408 or 410, one or more cooling sections 802, 1102 (see FIG. 8 to FIG. 10 below) and/or one or more cores 1202 (See FIG. 12 below) for cooling the ambient air 318 by transferring heat from the ambient air 318 to hydrogen from the liquid hydrogen tank 302. The hydrogen-based cooler 710 also includes one or more separator units 430 if required. In some examples, the compressor unit 714 includes a compressor 412, a motor 416 and a turbine 418, and operates as described above with reference to FIG. 4.

In use, ambient air passes through the hydrogen-based cooler 702, where it is cooled by the transfer of heat from the ambient air to hydrogen supplied from the liquid hydrogen tank 302. The cooled ambient air is then compressed by the compressor unit 704, after which is provided to the air-based cooler 708. The temperature of the ambient air after compression by the compressor unit 704 is sufficiently high above ambient temperature such that useful cooling can be provided by other ambient air. This cooling of the compressed air by the ambient air occurs in the air-based cooler 708, after which it is cooled further in the hydrogen-based cooler 710 by the transfer of heat from the ambient air to hydrogen supplied from the liquid hydrogen tank 302. The compressed and cooled air is then compressed further, in compressor unit 714. From there, the compressed air is either supplied to the fuel cell 306, or is cooled further, or cooled and compressed further, in one or more additional stages.

The inlet air compression and cooling system 700 thus takes advantage of the temperature differential between the initially-compressed air and the ambient air, to provide additional cooling of the compressed ambient air.

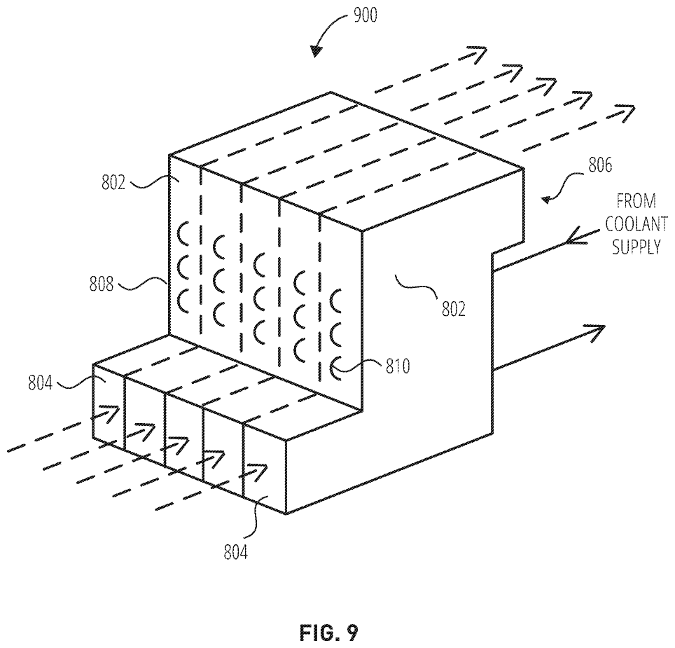

FIG. 8 is a schematic diagram illustrating a cooling section 802 of a multi-section inlet air hydrogen-based cooler 900 (see FIG. 9) for use in an inlet air cooling system according to some examples. The hydrogen-based cooler 900 in some examples replaces the body 402 and cooling elements 406, 408 of the inlet air cooling system 400 shown in FIG. 4.

The cooling section 802 is an example of one of the sections that form the hydrogen-based cooler 900. The cooling section 802 has an inlet 804 for warmer ambient air and an outlet 806 from which colder air leaves before going to a compressor such as the compressor 412. The cooling section 802 defines a conduit 808, containing a cooling core 810, along which air can flow from the inlet 804 to the outlet 806 and then to the compressor 412. The inlet 804 is at or in fluid communication with a port in the skin of the aircraft 100. The cooling core 810 is coupled to a coolant supply, which may be the heat exchanger 304 or which may be the liquid hydrogen tank 302.

In some examples, provided is a vane (not shown) that can be moved under control of the power electronics 208 between a first position in which airflow is diverted from the particular cooling section 802 and a second position in which inlet air can flow through the conduit 808 and cooling core 810, similar to the vane 414. The vane is operated by a motor (not shown) and may be retained in its various positions by latching mechanisms.

The cooling core 810 is in the form a multi-pass crossflow heat exchanger in which air flows through a large open area past fins (not shown) that cool the air progressively between the inlet 804 and the outlet 806. The fins are conductively isolated from adjacent layers of fins by air gaps or the like to limit heat conduction within the cooling core 810 in the direction of air flow, thereby increasing the cooling that can be imparted to the air passing through the cooling section 802. The inlet 804 is located lower in the aircraft 100 than the outlet 806 and may have a sloped floor such that any defrosted water or condensation 812 falling from the cooling core 810, in use or during a defrost cycle, drains out of the inlet 804.

FIG. 9 is a schematic diagram illustrating a hydrogen-based cooler 900 comprising multiple cooling sections 802, according to some examples. As can be seen, the cooling sections 802 are formed or assembled one next to the other to form a single unit in which adjacent cooling sections 802 share walls. Each cooling section 802 receives air from via an inlet 404, which then passes through the interior of the corresponding cooling section 802, where it transfers heat to the corresponding cooling core 810. Cooled air then leaves via the outlets 806 and is passed to an inlet compressor 412 as described previously. For reasons of clarity, the ducting to pass the outlet air to the compressor 412 is not shown in FIG. 9. The arrangement of FIG. 9 has the advantage of allowing smaller sections of the hydrogen-based cooler 900 to be sequentially isolated and defrosted while the rest of the hydrogen-based cooler 900 retains its overall cooling function.

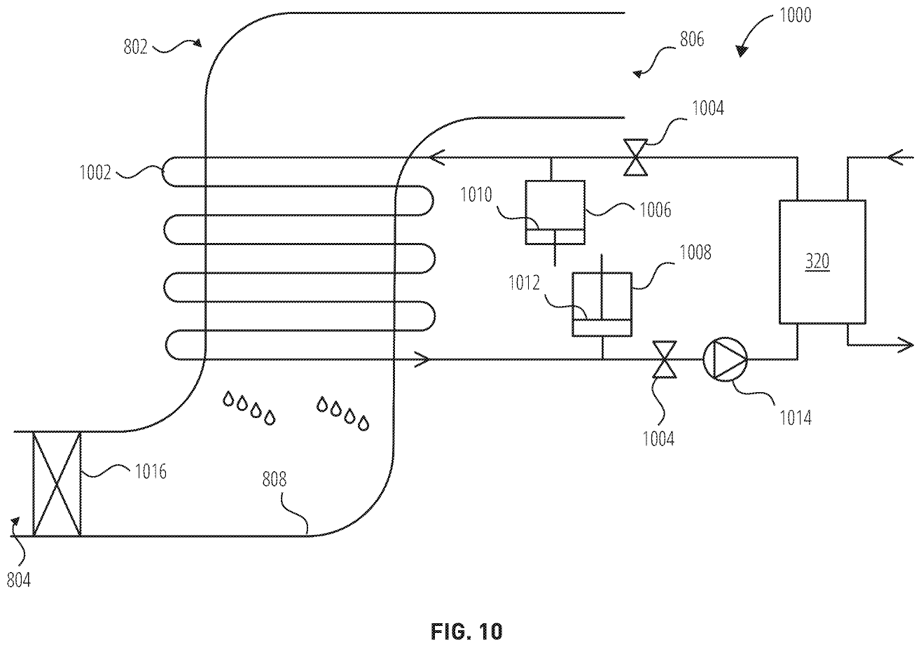

FIG. 10 is a schematic diagram illustrating a de-icing system 1000 for use in an inlet air cooling system, according to some examples. The de-icing system 1000 includes a warming core 1002, at least one valve 1004 (in some examples), a cold reservoir 1006, a warm reservoir 1008, and a pump 1014 to circulate coolant fluid between the heat exchanger 320 and the warming core 1002. Flow to and from the heat exchanger 320 for the warming core 1002 in the cooling section 802 in a hydrogen-based cooler 900 is selectively enabled by appropriate valving. That is, the heat exchanger 320 is shared by the warming cores 1002 of the de-icing system 1000, with each cooling core 810 having an associated warming core 1002. Connection of a particular warming core 1002 to the heat exchanger 320 is enabled as needed by the power electronics 208 to enable de-icing of the corresponding cooling core 810.

The cold reservoir 1006 includes a plunger 1010 to facilitate movement of coolant fluid into and out of the cold reservoir 1006 from and to the warming core 1002. Similarly, the warm reservoir 1008 includes a plunger 1012 to facilitate movement of coolant fluid into and out of the warm reservoir 1008 from and to the warming core 1002. One or both of the plungers 1010, plunger 1012 are operable by an actuator to facilitate the movement of the coolant fluid into or out of their respective cold reservoir 1006 and warm reservoir 1008. In some examples, operation of one of plunger 1010 or plunger 1012 via an actuator will generate pressure in the warming core 1002 that will move the other, passive plunger 1012 or plunger 1010, respectively. In some examples, the plungers 1010, plunger 1012 share an actuator such that movement of the actuator to advance one plunger will retract the other plunger.

In some examples, supplementary heating of the warm reservoir 1008 is provided from the heat exchanger 320 and/or supplementary cooling of the cold reservoir 1006 is provided from the heat exchanger 304 via additional conduits.

As the aircraft 100 gains altitude, the ambient air will get progressively colder, with a corresponding decrease in temperature in the air in the conduit 808. Depending on the ambient conditions, such as humidity and temperature, water vapor in the air is likely to condense and freeze on a cooling core 810 (not shown in FIG. 10). To resolve this problem, the coolant flow through that cooling core 810 is stopped, and a flow of warm coolant from heat exchanger 320 is circulated through the cooling section 802 via warming loop 322 to de-ice it. The warming core 1002 is adjacent to and in contact with the cooling core 810, either directly or via the fins of the cooling core 810, to facilitate transfer of heat from the warming core 1002 to the cooling core 810.

In some examples, each cooling section 802 also includes a vane 1016 that can be moved under control of the power electronics 208 between a first position in which airflow is diverted from the particular cooling section 802 during de-icing, and a second position in which inlet air can flow through the conduit 808 and the cooling core 810 during normal functioning of the particular cooling section 802.

During normal operation of the cooling section 802, the vane 1016 is in the second (open) position, air flows through the conduit 808 to be cooled by the cooling core 810 as discussed above. The valves 1004 are both shut and the pump 1014 is either shut off or supplying warm coolant to deice other warming cores 1002. The plunger 1012 has been withdrawn and the warm reservoir 1008 is filled with coolant while the cold reservoir 1006 is empty, “empty” and “full” being relative terms. Before a de-icing cycle has occurred, the coolant fluid in the warm reservoir 1008 will be at ambient temperature. After a de-icing cycle has occurred, the fluid in the warm reservoir 1008 will be warm coolant that has been withdrawn from the warming core 1002 before flow through the cooling core 810 recommences after de-icing is complete.

The presence of ice on a particular cooling core 810 in a particular cooling section 802 can be detected as described above with reference to FIG. 4. When the energy supply system 200 has determined that a particular cooling core 810 needs to be de-iced, the vane 1016 is moved to a position in which air cannot pass through the conduit 808, and flow through the cooling core 810 is stopped. The plunger 1012 is advanced so that the contents of the warm reservoir 1008 flow into the warming core 1002 while the plunger 1010 is retracted so the coolant in the warming core 1002, which has been cooled by operation of the cooling section 802, flows into the cold reservoir 1006. The valves 1004 are opened and the pump 1014 is activated (if not active already) to circulate warm coolant from the heat exchanger 320 through the warming core 1002 to de-ice the cooling section 802.

When the energy supply system 200 determines that de-icing of the particular cooling core 810 is complete, the valves 1004 are shut and the pump 1014 is deactivated if other warming cores 1002 are not engaged in a de-icing cycle. The plunger 1012 is retracted so that the contents of the warming core 1002 located in the conduit 808 flow into the warm reservoir 1008, while the plunger 1010 is advanced so the cold coolant in the cold reservoir 1006 flows into the warming core 1002. The vane 1016 is reopened and flow through the cooling core 810 recommences. These de-icing operations are performed by actuators and valves under control of the power electronics 208, and in response to sensors such as temperature sensors, which can be used to determine the state of the cooling cores 810 in the cooling sections 802.

The warm reservoir 1008 thus functions to remove warm coolant from the warming core 1002 before coolant flow through the cooling core 810 recommences, while the cold reservoir 1006 functions to remove cold coolant from the warming core 1002 before de-icing commences. The warming core 1002 thus does not have to warm up coolant that has been chilled by operation of the cooling core 810, making de-icing more efficient, while the cooling core 810 similarly does not have to cool warm coolant in the warming core 1002 when flow through the cooling core 810 recommences, making the cooling of the air in the conduit 808 more efficient.

The de-icing system 1000 illustrated in FIG. 10 includes a cooling section 802 in which the cooling core 810 does not share coolant with the warming core 1002. This may be required in situations in which the coolant in the cooling core 810 is incompatible with the coolant in the warming core 1002, for example if hydrogen from the liquid hydrogen tank 302 passes through the cooling core 810 to cool the air in the conduit 808. In other examples, the cooling core 810 and the warming core 1002 may be integrated as described with reference to FIG. 11.

FIG. 11 is a schematic diagram illustrating a cooling section 1102 of a combined de-icing and air cooling system 1100 for use in an inlet air cooling system according to some examples. Cooling sections 1102 are assembled into an inlet-air cooler such as hydrogen-based cooler 900 discussed above with reference to FIG. 9.

The de-icing and air cooling system 1100 includes a combined warming and cooling core 1104, at least one valve 1004 (in some examples), a cold reservoir 1006, a warm reservoir 1008, a pump 1014 to circulate coolant fluid between the heat exchanger 320 and the warming core 1002, and two three-way valves 1106 to switch the warming and cooling core 1104 alternately between the heat exchanger 304 to cool the air in the conduit 808 and the heat exchanger 320 to defrost the warming and cooling core 1104. Flow to and from the heat exchangers 304, 320 for each warming and cooling core 1104 in a hydrogen-based cooler 900 is selectively enabled by appropriate valving. That is, the connection of a particular core 1202 to the heat exchanger 1204 is enabled as needed by the power electronics 208 for cooling or de-icing of that particular core 1202.

During normal operation of the cooling section 1102, the vane 1016 is in the second (open) position, air flows through the conduit 808 to be cooled by the warming and cooling core 1104 which is connected to the heat exchanger 304 by the appropriate positioning of the valves 1106. The valves 1004 are both shut and the pump 1014 is shut off or supplying other warming and cooling cores 1104. The plunger 1012 has been withdrawn and the warm reservoir 1008 is filled with coolant while the cold reservoir 1006 is empty, “empty” and “full” being relative terms. Before a de-icing cycle has occurred, the coolant fluid in the warm reservoir 1008 will be at ambient temperature. After a de-icing cycle has occurred, the fluid in the warm reservoir 1008 will be warm coolant that has been withdrawn from the warming and cooling core 1104 before cooling flow through the warming and cooling core 1104 recommences after de-icing is complete.

The presence of ice on a particular warming and cooling core 1104 in a particular cooling section 1102 can be detected as described above with reference to FIG. 4. When the energy supply system 200 has determined that a particular warming and cooling core 1104 needs to be de-iced, the vane 1016 is moved to a position in which air cannot pass through the conduit 808, and the valves 1106 are positioned so as to disconnect the warming and cooling core 1104 from the heat exchanger 304 and to connect it to the heat exchanger 320. The plunger 1012 is then advanced so that the contents of the warm reservoir 1008 flow into the warming and cooling core 1104 while the plunger 1010 is retracted so the coolant in the warming and cooling core 1104, which has been cooled by virtue of coolant flowing from heat exchanger 304, flows into the cold reservoir 1006. The valves 1004 are opened and the pump 1014 is activated (if not active already) to circulate warm coolant from the heat exchanger 320 through the warming and cooling core 1104 to de-ice the cooling section 1102.

When the energy supply system 200 determines that de-icing of the particular warming and cooling core 1104 is complete, the pump 1014 is deactivated (if appropriate) and the valves 1004 are shut. The plunger 1012 is retracted so that the contents of the warming and cooling core 1104 located in the conduit 808 flow into the warm reservoir 1008, while the plunger 1010 is advanced so the cold coolant in the cold reservoir 1006 flows into the warming and cooling core 1104. The vane 1016 is reopened and flow through the cooling section 1102 recommences. These de-icing operations are performed by actuators and valves under control of the power electronics 208, and in response to sensors such as temperature sensors, which can be used to determine the state of the warming and cooling cores 1104 in the different cooling sections 1102.

The warm reservoir 1008 thus functions to remove warm coolant from the warming and cooling core 1104 before cooling flow from the heat exchanger 304 recommences, while the cold reservoir 1006 functions to remove cold coolant from the warming and cooling core 1104 before warming flow from the heat exchanger 320 for de-icing commences. Cold coolant from the heat exchanger 304 is thus not mixed with warm coolant from the heat exchanger 320 when cooling sections 1102 in the combined de-icing and air cooling system 1100 alternate between cooling inlet air in the conduit 808 and being de-iced, making the de-icing and air cooling system 1100 more efficient.

FIG. 12 is a schematic diagram illustrating air cooling system 1200 for use in a fuel cell system 300 according to some examples. FIG. 12 illustrates the hydrogen-based cooler 900 and conduit from above compared to the side views shown in FIG. 10 and FIG. 11.

The air cooling system 1200 includes heat transfer loop 1206 comprising multiple cores 1202, an inlet manifold 1208 to supply heat transfer fluid to the cores 1202, an outlet manifold 1210 to receive heat transfer fluid from the core 1202, a number of valves 1004 to control supply of heat transfer fluid to each core 1202, and a pump 1014 to circulate heat transfer fluid around the heat transfer loop 1206.

In some examples, the heat exchanger 1204 is the heat exchanger 304, in which case the cores 1202 are cooling cores 810 for cooling the inlet air. In some examples, the heat exchanger 1204 is the heat exchanger 320, in which case the cores 1202 are warming cores 1002 for defrosting the cooling cores 810. In further examples, the cores 1202 may be joint warming and cooling cores 1104, in which case appropriate valving and connections are provided to connect each core 1202 alternately to the heat exchanger 304 and the heat exchanger 320 as described in FIG. 11.

That is, heat transfer loop 1206 is either a cooling loop comprising cooling cores 810 operating as described with reference to FIG. 8 and FIG. 9, a de-icing loop comprising warming cores 1002 operating as described with reference to FIG. 10, or a combined cooling and de-icing loop comprising warming and cooling cores 1104 functioning as described with reference to FIG. 11. The heat exchanger 1204 is then either the heat exchanger 304 or the heat exchanger 320 respectively for the first two cases, or the heat exchanger 1204 comprises both heat exchanger 304 and heat exchanger 320, which are provided for the latter case, connected as described with reference to FIG. 11.

Under computer control of the power electronics 208 or other aircraft system processors, each valve 1004 is then operated to provide heat transfer fluid to a corresponding core 1202 to either cool the inlet air in the conduit 808 or to de-ice the core 1202 as appropriate.

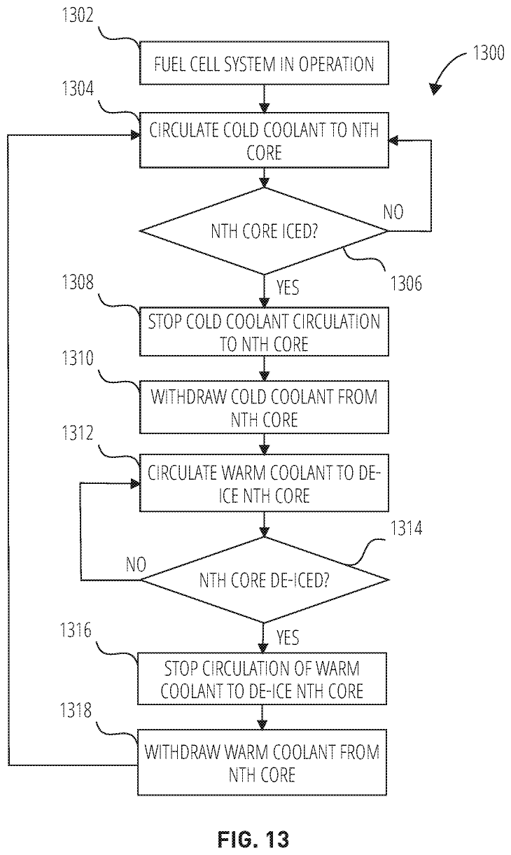

FIG. 13 is a flowchart 1300 illustrating operation of the fuel cell system 300 including the air cooling systems illustrated in FIG. 8 to FIG. 12, according to some examples. The flowchart is performed by the fuel cell system 300 and air cooling system 1200 under computer control of the power electronics 208 or other aircraft system processors. The method steps are accomplished by the power electronics 208 providing control signals to corresponding components in the system, such as valves 1004, pump 1014, and so forth. The method steps are initiated by the power electronics 208 based at least in part on signals received from sensors located in the systems 300, 1200, including for example temperature sensors located in the cores 1202.

The flowchart 1300, which is described with reference to one (the “nth”) of the cores 1202 commences at operation 1302 in FIG. 13, in which the fuel cell system 300 is operating. Liquid hydrogen from liquid hydrogen tank 302 is provided to the heat exchanger 304, where it receives heat from coolant flowing in the coolant loop 316. The hydrogen is then passed to fuel cell 306, which generates power 310, heat 312 and exhaust 314. Heat 312 is passed from the fuel cell 306 to the coolant in warming loop 322 in heat exchanger 320. Ambient air 318 received in inlet 804 of air cooling system 1200 is cooled and compressed by the inlet air compression and cooling system 308, and provided to fuel cell 306. Pump 1014 is operating to circulate coolant from the heat exchanger 304 through the nth core 1202 to cool the inlet air entering the conduit 808.

In operation 1306, the power electronics 208 determines if the nth core 1202 has become iced, based on signals received from temperature sensors in or at the nth core 1202. If the nth core 1202 has not become iced, the method returns to operation 1304 for continued circulation of cold coolant to the nth core 1202.

If the nth core 1202 is or has become iced, the method proceeds to operation 1308 where cold coolant circulation to the nth core 1202 is terminated by the power electronics 208 operating the corresponding valve 1004 to stop cold coolant from flowing to nth core 1202. In some examples, the valve vane 1016 is also operated to stop flow of air through the conduit 808, and the cold fluid in the adjacent warming core 1002 or in the nth core 1202 is withdrawn prior to circulation of the warm cooling fluid as described above with reference to FIG. 10 or FIG. 11, in operation 1310.

In operation 1312, the power electronics 208 operates appropriate valves to circulate warm coolant to defrost the nth core 1202. This circulation can be either though an adjacent warming core 1002 as described with reference to FIG. 10 if the core 1202 is a cooling section 802, or through the nth core 1202 itself as described with reference to a combined system as described in FIG. 11.

In operation 1314, the power electronics 208 determines if the nth core 1202 has become de-iced, based on signals received from temperature sensors in or at the nth core 1202. If the nth core 1202 has not become de-iced, the method returns to operation 1312 for continued circulation of warm coolant to de-ice the nth core 1202.

If the nth core 1202 is or has become de-iced, the method proceeds to operation 1316 where warm coolant circulation to the nth core 1202 is terminated by the power electronics 208 operating the appropriate valve(s). In some examples, the warm fluid in the adjacent warming core 1002 or in the nth core 1202 is withdrawn as described above with reference to FIG. 11 or FIG. 12, in operation 1318, which returns the withdrawn cold fluid to the adjacent warming core 1002 or the core 1202. The method then returns to operation 1304 and circulation of cold coolant to the nth core 1202 is restarted, and the method proceeds from there.
Various examples are contemplated. Example 1 is a method of operating a fuel cell system including a fuel cell that receives inlet air from the ambient environment via a conduit, the method comprising: receiving hydrogen from a supply of hydrogen; circulating a coolant fluid through a first cooling loop located in the conduit containing the inlet air, thereby to transfer heat to the hydrogen from the inlet air to cool the inlet air; compressing the cooled inlet air to generate compressed air; and supplying the compressed air to the fuel cell, the method further comprising: determining that ice has formed on the first cooling loop; based on determining that ice has formed on the first cooling loop, ceasing circulation of coolant fluid through the first cooling loop; and based on determining that ice has formed on the first cooling loop, de-icing the first cooling loop.
In Example 2, the subject matter of Example 1 includes, based on determining that ice has formed on the first cooling loop, circulating coolant fluid through a second cooling loop located in the conduit.
In Example 3, the subject matter of Examples 1-2 includes, wherein the de-icing of the first cooling loop comprises: circulating a warm coolant fluid through the first cooling loop.
In Example 4, the subject matter of Examples 1-3 includes, wherein the de-icing of the first cooling loop is performed using electrical heating.
In Example 5, the subject matter of Examples 1˜4 includes, wherein the de-icing of the first cooling loop comprises: transferring heat from the fuel cell to a warming fluid; and circulating the warming fluid through a first warming loop located at the first cooling loop.
In Example 6, the subject matter of Example 5 includes, wherein the first cooling loop and the first warming loop share a core located in the conduit.
In Example 7, the subject matter of Examples 5-6 includes, removing cold warming fluid located in the conduit from the first warming loop before circulating the warming fluid through the first warming loop.
In Example 8, the subject matter of Example 7 includes, removing warm warming fluid located in the conduit from the first warming loop before recommencing circulation of coolant fluid through the first cooling loop located in the conduit.
In Example 9, the subject matter of Examples 2-8 includes, moving a vane between a first position in which it shields the first cooling loop from air moving through the conduit and a second position in which it shields the second cooling loop from air moving through the conduit.
In Example 10, the subject matter of Examples 2-9 includes, based on determining that ice has formed on the second cooling loop, circulating a warm coolant fluid through a second warming loop located at the second cooling loop.
In Example 11, the subject matter of Examples 1-10 includes, wherein the coolant fluid comprises the hydrogen from the supply of hydrogen.
Example 12 is a fuel cell system including a fuel cell powered by hydrogen received from a supply of hydrogen, the fuel cell system comprising: a compressor to compress air to generate compressed air for provision to the fuel cell; a conduit to supply air to the compressor; a first heat exchanger located in the conduit to cool the air supplied to the compressor by transferring heat to the hydrogen from a coolant fluid located in a cooling loop; a second heat exchanger located in the conduit to cool the air supplied to the compressor by transferring heat to the hydrogen from the coolant fluid located in the cooling loop; a manifold to supply coolant fluid to the first heat exchanger and the second heat exchanger; and a plurality of valves to selectively supply coolant fluid from the manifold to the first heat exchanger and to the second heat exchanger.
Example 13 is a fuel cell system including a fuel cell powered by hydrogen received from a supply of hydrogen, the fuel cell system comprising: a first heat exchanger to transfer heat to the hydrogen from a coolant fluid located in a cooling loop; a compressor to compress air to generate compressed air for provision to the fuel cell; a conduit to supply air to the compressor; and a second heat exchanger located in the conduit to cool the air supplied to the conduit, by transferring heat from air in the conduit to the coolant fluid from the first heat exchanger.
In Example 14, the subject matter of Example 13 includes, a third heat exchanger to transfer heat from the fuel cell to a warming fluid located in a warming loop; and a fourth heat exchanger located in the conduit to de-icing at least part of the second heat exchanger by transferring heat from the warming fluid to the second heat exchanger.
In Example 15, the subject matter of Examples 13-14 includes, wherein the second heat exchanger comprises a first cooling loop and a second cooling loop and wherein the cooling loop comprises a cooling loop valve to selectively directing the coolant fluid to either the first cooling loop or the second cooling loop.
In Example 16, the subject matter of Example 15 includes, a third heat exchanger to transfer heat from the fuel cell to a warming fluid located in a warming loop; a fourth heat exchanger located in the conduit to de-icing at least part of the second heat exchanger by transferring heat from the warming fluid to the second heat exchanger; and a warming loop valve being operable to direct the warming fluid to de-ice either the first cooling loop or the second cooling loop.
In Example 17, the subject matter of Examples 15-16 includes, a vane being movable between a first position in which it shields the first cooling loop from air moving through the conduit and a second position in which it shields the second cooling loop from air moving through the conduit.
In Example 18, the subject matter of Examples 16-17 includes, a vane being movable between a first position in which it shields the first cooling loop from air moving through the conduit and a second position in which it shields the second cooling loop from air moving through the conduit, the warming loop valve directing warming fluid to de-ice the first cooling loop when the vane is in the first position and the warming loop valve directing the warming fluid to de-ice the second cooling loop when the vane is in the second position.
In Example 19, the subject matter of Example 18 includes, wherein the conduit and the second heat exchanger are arranged such that water dripping off the second heat exchanger drains towards an inlet end of the conduit.
In Example 20, the subject matter of Examples 13-19 includes, one or more additional exchangers located in the conduit in parallel with the second heat exchanger, to cool the air supplied to the conduit, by transferring heat from air in the conduit to the coolant fluid from the one or more additional exchangers.
Example 21 is at least one machine-readable medium including instructions that, when executed by processing circuitry, cause the processing circuitry to perform operations to implement of any of Examples 1-20. Example 22 is an apparatus comprising means to implement of any of Examples 1-20. Example 23 is a system to implement of any of Examples 1-20. Example 24 is a method to implement of any of Examples 1-20.

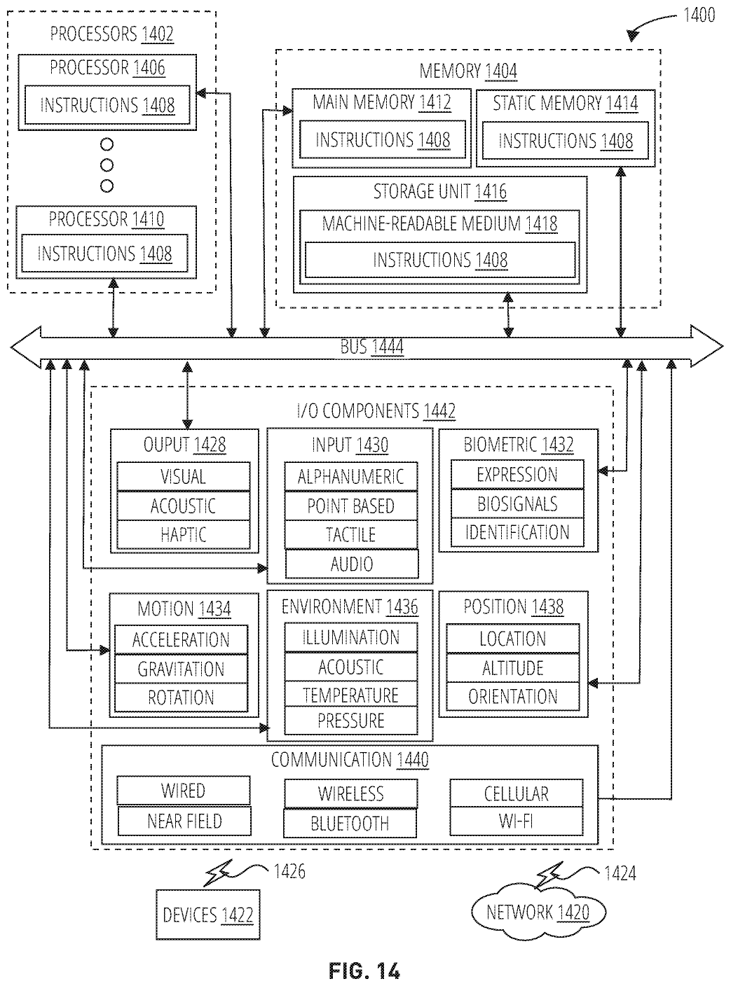

FIG. 14 illustrates a diagrammatic representation of a machine 1400 in the form of a computer system within which a set of instructions may be executed for causing the machine to perform any one or more of the methodologies discussed herein, according to an example. For example, power electronics 208 may be embodied as machine 1400.

Specifically, FIG. 14 shows a diagrammatic representation of the machine 1400 in the example form of a computer system, within which instructions 1408 (e.g., software, a program, an application, an applet, an app, or other executable code) for causing the machine 1400 to perform any one or more of the methodologies discussed herein may be executed. The instructions 1408 transform the general, non-programmed machine 1400 into a particular machine 1400 programmed to carry out the described and illustrated functions in the manner described. In alternative examples, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1408, sequentially or otherwise, that specify actions to be taken by the machine 1400. Further, while only a single machine 1400 is illustrated, the term “machine” shall also be taken to include a collection of machines 1400 that individually or jointly execute the instructions 1408 to perform any one or more of the methodologies discussed herein.

The machine 1400 may include processors 1402, memory 1404, and I/O components 1442, which may be configured to communicate with each other such as via a bus 1444. In an example, the processors 1402 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1406 and a processor 1410 that may execute the instructions 1408. The term “processor” is intended to include multi-core processors that may comprise two or more independent processors (sometimes referred to as “cores”) that may execute instructions contemporaneously. Although FIG. 14 shows multiple processors 1402, the machine 1400 may include a single processor with a single core, a single processor with multiple cores (e.g., a multi-core processor), multiple processors with a single core, multiple processors with multiples cores, or any combination thereof.

The memory 1404 may include a main memory 1412, a static memory 1414, and a storage unit 1416, both accessible to the processors 1402 such as via the bus 1444. The main memory 1404, the static memory 1414, and storage unit 1416 store the instructions 1408 embodying any one or more of the methodologies or functions described herein. The instructions 1408 may also reside, completely or partially, within the main memory 1412, within the static memory 1414, within machine-readable medium 1418 within the storage unit 1416, within at least one of the processors 1402 (e.g., within the processor's cache memory), or any suitable combination thereof, during execution thereof by the machine 1400.

The I/O components 1442 may include a wide variety of components to receive input, provide output, produce output, transmit information, exchange information, capture measurements, and so on. The specific I/O components 1442 that are included in a particular machine will depend on the type of machine. For example, portable machines such as mobile phones will likely include a touch input device or other such input mechanisms, while a headless server machine will likely not include such a touch input device. It will be appreciated that the I/O components 1442 may include many other components that are not shown in FIG. 14. The I/O components 1442 are grouped according to functionality merely for simplifying the following discussion and the grouping is in no way limiting. In various examples, the I/O components 1442 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1442 may include biometric components 1432, motion components 1434, environmental components 1436, or position components 1438, among a wide array of other components. For example, the biometric components 1432 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 may include acceleration sensor components (e.g., accelerometer), gravitation sensor components, rotation sensor components (e.g., gyroscope), and so forth. The environmental components 1436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1438 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1442 may include communication components 1440 operable to couple the machine 1400 to a network 1420 or devices 1422 via a coupling 1424 and a coupling 1426, respectively. For example, the communication components 1440 may include a network interface component or another suitable device to interface with the network 1420. In further examples, the communication components 1440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1422 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 1404, main memory 1412, static memory 1414, and/or memory of the processors 1402) and/or storage unit 1416 may store one or more sets of instructions and data structures (e.g., software) embodying or utilized by any one or more of the methodologies or functions described herein. These instructions (e.g., the instructions 1408), when executed by processors 1402, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 1420 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1420 or a portion of the network 1420 may include a wireless or cellular network, and the coupling 1424 may be a Code Division Multiple Access (CDMA) connection, a Global System for Mobile communications (GSM) connection, or another type of cellular or wireless coupling. In this example, the coupling 1424 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1408 may be transmitted or received over the network 1420 using a transmission medium via a network interface device (e.g., a network interface component included in the communication components 1440) and utilizing any one of a number of well-known transfer protocols (e.g., hypertext transfer protocol (HTTP)). Similarly, the instructions 1408 may be transmitted or received using a transmission medium via the coupling 1426 (e.g., a peer-to-peer coupling) to the devices 1422. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1408 for execution by the machine 1400, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Examples of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention disclosed herein without departing from the scope of this invention defined in the following claims.

What is claimed is:

1. A method of operating a fuel cell system including a fuel cell that receives inlet air from the ambient environment via a conduit, the method comprising:
receiving hydrogen from a supply of hydrogen;
circulating a coolant fluid through a first cooling loop located in the conduit containing the inlet air, thereby to transfer heat to the hydrogen from the inlet air to cool the inlet air;
compressing the cooled inlet air to generate compressed air; and
supplying the compressed air to the fuel cell,
the method further comprising:
determining that ice has formed on the first cooling loop;
based on determining that ice has formed on the first cooling loop, ceasing circulation of coolant fluid through the first cooling loop; and
based on determining that ice has formed on the first cooling loop, de-icing the first cooling loop.

2. The method of claim 1, further comprising:
based on determining that ice has formed on the first cooling loop, circulating coolant fluid through a second cooling loop located in the conduit.

3. The method of claim 1, wherein the de-icing of the first cooling loop comprises:
circulating a warm coolant fluid through the first cooling loop.

4. The method of claim 1, wherein the de-icing of the first cooling loop is performed using electrical heating.

5. The method of claim 1, wherein the de-icing of the first cooling loop comprises:
transferring heat from the fuel cell to a warming fluid; and
circulating the warming fluid through a first warming loop located at the first cooling loop.

6. The method of claim 5, wherein the first cooling loop and the first warming loop share a core located in the conduit.

7. The method of claim 5, further comprising:
removing cold warming fluid located in the conduit from the first warming loop before circulating the warming fluid through the first warming loop.

8. The method of claim 7, further comprising:
removing warm warming fluid located in the conduit from the first warming loop before recommencing circulation of coolant fluid through the first cooling loop located in the conduit.

9. The method of claim 2, further comprising:
moving a vane between a first position in which it shields the first cooling loop from air moving through the conduit and a second position in which it shields the second cooling loop from air moving through the conduit.

10. The method of claim 2, further comprising:
based on determining that ice has formed on the second cooling loop, circulating a warm coolant fluid through a second warming loop located at the second cooling loop.

11. The method of claim 1, wherein the coolant fluid comprises the hydrogen from the supply of hydrogen.

12. A fuel cell system including a fuel cell powered by hydrogen received from a supply of hydrogen, the fuel cell system comprising:
a compressor to compress air to generate compressed air for provision to the fuel cell;
a conduit to supply air to the compressor;
a first heat exchanger located in the conduit to cool the air supplied to the compressor by transferring heat to the hydrogen from a coolant fluid located in a cooling loop;
a second heat exchanger located in the conduit to cool the air supplied to the compressor by transferring heat to the hydrogen from the coolant fluid located in the cooling loop;
a manifold to supply coolant fluid to the first heat exchanger and the second heat exchanger; and
a plurality of valves to selectively supply coolant fluid from the manifold to the first heat exchanger and to the second heat exchanger.

13. A fuel cell system including a fuel cell powered by hydrogen received from a supply of hydrogen, the fuel cell system comprising:
a first heat exchanger to transfer heat to the hydrogen from a coolant fluid located in a cooling loop;
a compressor to compress air to generate compressed air for provision to the fuel cell;
a conduit to supply air to the compressor; and
a second heat exchanger located in the conduit to cool the air supplied to the conduit, by transferring heat from air in the conduit to the coolant fluid from the first heat exchanger.

14. The fuel cell system of claim 13, further comprising:
a third heat exchanger to transfer heat from the fuel cell to a warming fluid located in a warming loop; and
a fourth heat exchanger located in the conduit to de-icing at least part of the second heat exchanger by transferring heat from the warming fluid to the second heat exchanger.

15. The fuel cell system of claim 13, wherein the second heat exchanger comprises a first cooling loop and a second cooling loop and wherein the cooling loop comprises a cooling loop valve to selectively directing the coolant fluid to either the first cooling loop or the second cooling loop.

16. The fuel cell system of claim 15, further comprising:
a third heat exchanger to transfer heat from the fuel cell to a warming fluid located in a warming loop;
a fourth heat exchanger located in the conduit to de-icing at least part of the second heat exchanger by transferring heat from the warming fluid to the second heat exchanger; and
a warming loop valve being operable to direct the warming fluid to de-ice either the first cooling loop or the second cooling loop.

17. The fuel cell system of claim 15, further comprising a vane being movable between a first position in which it shields the first cooling loop from air moving through the conduit and a second position in which it shields the second cooling loop from air moving through the conduit.

18. The fuel cell system of claim 16, further comprising a vane being movable between a first position in which it shields the first cooling loop from air moving through the conduit and a second position in which it shields the second cooling loop from air moving through the conduit, the warming loop valve directing warming fluid to de-ice the first cooling loop when the vane is in the first position and the warming loop valve directing the warming fluid to de-ice the second cooling loop when the vane is in the second position.

19. The fuel cell system of claim 18, wherein the conduit and the second heat exchanger are arranged such that water dripping off the second heat exchanger drains towards an inlet end of the conduit.

20. The fuel cell system of claim 13, further comprising one or more additional exchangers located in the conduit in parallel with the second heat exchanger, to cool the air supplied to the conduit, by transferring heat from air in the conduit to the coolant fluid from the one or more additional exchangers.
